(19) United States
(12) Patent Application Publication
(10) Pub. No.: US 2016/0173551 A1
(43) Pub. Date: Jun. 16, 2016

(54) SYSTEM AND METHOD FOR SESSION MOBILITY FOR ADAPTIVE BITRATE STREAMING

(71) Applicant: bitmovin GmbH, Klagenfurt (AT)

(72) Inventors: Christopher MUELLER, Villach (AT); Stefan LEDERER, Klagenfurt (AT); Christian TIMMERER, Klagenfurt (AT)

(21) Appl. No.: 15/051,423

(22) Filed: Feb. 23, 2016

Related U.S. Application Data
(63) Continuation of application No. PCT/EP2014/067909, filed on Aug. 22, 2014.
(60) Provisional application No. 61/869,072, filed on Aug. 23, 2013.

(51) Int. Cl. H04L 29/06; H04L 29/08

(52) U.S. Cl. CPC H04L 65/601; H04L 65/4084; H04L 67/02; H04L 67/148

(57) ABSTRACT

A system is provided, having a server, a first device for receiving a first plurality of segments of a media data stream from the server, and a second device for receiving a second plurality of segments of the media data stream from the server. A processor of the second device is configured to select said second plurality of segments of the media data stream depending on the context information, and depending on a replay offset or on a segment being rendered last by the first device or on a segment being received last by the first device. The interface of the second device is configured to request said second plurality of segments from the server. The server is configured to transmit said second plurality of segments to the second device.

### CROSS-REFERENCE TO RELATED APPLICATIONS

This application is a continuation of copending International Application No. PCT/EP2014/067909, filed Aug. 22, 2014, which claims priority from U.S. Provisional Application No. 61/869,072, filed Aug. 23, 2013, which are each incorporated herein in its entirety by this reference thereto.

### BACKGROUND OF THE INVENTION

The present invention relates to data streaming, and, in particular, to a system and method for session mobility for adaptive bitrate streaming.

Video and audio streaming becomes increasingly important.

According to a first approach in known technology, a user logs on from a remote device, e.g., a remote client, to a server. The user selects a video from a collection of videos that are presented to the user by the server, and after selecting the video, the streaming starts. For this purpose, client software that is compatible with the server is installed at the client side that allows the client to log in at the server and to receive the selected video as a video stream.

At the server side, the server administers all relevant data regarding the video stream.

For example, the server stores, which segment of a plurality of segments was the last segment that was transmitted to the client. Or, the server stores the current replay time of the video. E.g., a replay time of 30:20 may indicate that the last transmitted segment relates to minute 30, second 20 of the video.

Moreover, the server, may, e.g., store, which audio track from a plurality of audio tracks was selected by the user for this video (e.g., the audio track “English” from a group of two available audio tracks “English” and “French”). Furthermore, the server stores, which subtitle of a plurality of subtitles was selected by the user (e.g., the subtitle “German” from a group of five available subtitles “English”, “French”, “German”, “Spanish” and “Italian”). Moreover, the server, may, e.g., store a video data rate that was selected by the user from a plurality of data rates (e.g., a data rate 2 mbps may be selected by the user from the group of available data rates 1 mbps, 2 mbps and 4 mbps; mbps=megabits per second).

In known technology, when a user stops the replay of the video and logs out, the server may store, where the user interrupted replaying the video (for example, the server stores that the last transmitted segment had the segment number “2319”, or, for example, the server stores that the replay of the video was stopped at replay time 37:25). Moreover, according to known technology, the server may store the selected settings of the user, for example, the selected audio track, the selected subtitle, or the selected quality.

According to known technology, when the user again logs on to the server from a client to replay the video, the server reads the stored information on the last replay of the video from the server memory and replays the video starting at the replay time at which the video was stopped when the user logged out last time from the server. Moreover, the server uses the settings, e.g., selected by the user when the user was logged in last time, as these settings are stored in the memory of the server and are thus available, when the user again logs in. These settings may, for example, be the selected audio track, the selected subtitle or the selected data rate of the video.

When the user again logs in on the server, the user may use a different client than the client used in the previous log in session. For example, the user may have started to watch the video on his personal computer. He then logged out and again logged in on the server with his tablet computer and continues to watch the video with the same settings automatically starting from the replay time where he interrupted the video. The user may, e.g., again log out and then log in from his smartphone to continue watching the video with the same settings starting from the replay time where the user previously stopped the video when he logged out from his tablet computer.

Similar concepts exist in known technology for audio streams, e.g., for music streams.

However, the above-described known technology has the disadvantage that the server has to store all information in a server memory that relates to all relevant user streams. For example, consider the example, that an average user, during the months and years of using a (e.g., video and music) streaming service of a content provider, accessed e.g., a total of 10.000 audio and video streams. If storing the settings of one stream necessitates, e.g., 0.01 MB (0.01 megabyte) of memory, this results in 100 Megabyte of memory needed for every user. Assuming that the content provider has, for example, 10 million users, this results to a memory requirement of 10.000.000*100 MB=1.000.000.000 MB=1000 TB (1000 terabyte)=1 PB (1 petabyte). Assuming that the content provider should at least have one backup server, this results in a memory requirement of 2 PB petabyte=2000 TB. Of course, the content provider does not only have to buy the memory, but also has to constantly administer the memory, e.g., check the memory for memory faults, etc, and complex database systems are necessitated to quickly access the information when needed, etc.

Moreover, as all information is stored on the server, the devices, e.g., clients, that want to access the server have to log in at the server with software, which has to be installed on the devices (clients), wherein said software has to be fully compatible with the server. This results, in most cases, to the requirement that proprietary software has to installed on each of the clients which want to access the server streaming services.

In view of the above-described disadvantages of the known technology, it would be highly appreciated if concepts would be provided that allow to smoothly switch between different devices/clients when receiving a media stream from a server, while keeping the requirements with respect to the server low.

### SUMMARY

According to an embodiment, a system may have: a server, a first device for receiving a first plurality of segments of a media data stream from the server, and a second device for receiving a second plurality of segments of the media data stream from the server, wherein an interface of the first device is configured to receive manifest information indicating, for each property of one or more properties of the media data stream, a group of two or more available versions of said property of the media data stream, wherein a processor of the first device is configured to select, for each of the one or more properties, one of the two or more available versions of said property as a selected version of said property, to determine context information having the selected version of each of the one or more properties, wherein the interface of the first device is configured to request said first plurality of segments of the media data stream depending on the context information, wherein the server is configured to transmit said first plurality of segments to the first device, wherein an interface of the second device is configured to receive the context information and information on a replay offset or on the segment being rendered last by the first device or on the segment being received last by the first device, wherein said replay offset depends on a replay of the media data stream at the first device, wherein a processor of the second device is configured to select said second plurality of segments of the media data stream depending on the context information, and depending on the replay offset or on the segment being rendered last by the first device or on the segment being received last by the first device, wherein the interface of the second device is configured to request said second plurality of segments from the server, and wherein the server is configured to transmit said second plurality of segments to the second device.

According to another embodiment, a device for receiving a plurality of segments of a media data stream may have: an interface for receiving context information and information on a replay offset or on a segment being rendered last by another device or on a segment being received last by the other device, wherein said replay offset depends on a replay of the media data stream at the other device, and a processor for selecting said plurality of segments of the media data stream depending on the context information, and depending on the replay offset or on the segment being rendered last by the other device or on the segment being received last by the other device, wherein the interface is configured to request said plurality of segments, and wherein the interface is configured to receive said plurality of segments.

According to another embodiment, a server may have: an interface for transmitting initial manifest information indicating two or more versions for each of one or more properties of a media data stream, and a processor, wherein the interface is configured to receive context information indicating a selected version for each of the one or more properties of the media data stream, wherein the processor is configured to modify the initial manifest information to obtain modified manifest information depending on the context information, wherein the interface is configured to transmit the modified manifest information, wherein the interface is configured to receive a request requesting one or more segments of the media data stream, wherein the request depends on the modified manifest information, and wherein the interface is configured to transmit said one or more segments of the media data stream.

According to another embodiment, a method may have the steps of: transmitting manifest information to a first device, wherein the manifest information indicates, for each property of one or more properties of the media data stream, a group of two or more available versions of said property of the media data stream, conducting a selection at the first device such that, for each of the one or more properties, one of the two or more available versions of said property are selected as a selected version of said property, to determine context information having the selected version of each of the one or more properties, requesting by the first device a first plurality of segments of the media data stream depending on the context information, transmitting said first plurality of segments from a server to the first device, transmitting from the first device to a second device the context information and information on a replay offset or on the segment being rendered last by the first device or on the segment being received last by the first device, wherein said replay offset depends on a replay of the media data stream at the first device, conducting a selection by the second device, such that a second plurality of segments of the media data stream is selected depending on the context information, and depending on the replay offset or on the segment being rendered last by the first device or on the segment being received last by the first device, transmitting a request for said second plurality of segments from the second device to the server, and transmitting said second plurality of segments from the server to the second device.

According to still another embodiment, a method for receiving a plurality of segments of a media data stream may have the steps of: receiving, at a first device, context information and information on a replay offset or on a segment being rendered last by another device or on a segment being received last by the other device, wherein said replay offset depends on a replay of the media data stream at a second device, selecting at the first device said plurality of segments of the media data stream depending on the context information, and depending on the replay offset or on the segment being rendered last by the other device or on the segment being received last by the other device, requesting said plurality of segments, and receiving said plurality of segments.

According to another embodiment, a method may have the steps of: transmitting initial manifest information indicating two or more versions for each of one or more properties of a media data stream, receiving context information indicating a selected version for each of the one or more properties of the media data stream, modifying the initial manifest information to obtain modified manifest information depending on the context information, transmitting the modified manifest information, receiving a request requesting one or more segments of the media data stream, wherein the request depends on the modified manifest information, and transmitting said one or more segments of the media data stream.

Another embodiment may have a computer program for implementing the above-described methods when being executed on a computer or signal processor is provided.

### BRIEF DESCRIPTION OF THE DRAWINGS

In the following, embodiments of the present invention are described in more detail with reference to the Figures, in which:

FIG. 1 illustrates a system according to an embodiment,

FIG. 2 illustrates a session mobility architecture according to an embodiment,

FIG. 3 illustrates a session mobility architecture according to another embodiment with compatible devices,

FIG. 4 illustrates a session mobility architecture according to a further embodiment with incompatible devices, wherein device A understands the manifest,

FIG. 5 illustrates a session mobility architecture according to another embodiment with incompatible Devices, wherein a server based modification employs one or more cookies,

FIG. 6 illustrates a session mobility architecture according to a further embodiment with incompatible devices, wherein a server based modification employs headers,

FIG. 7 illustrates a device for receiving a plurality of segments of a media data stream according to an embodiment, and

FIG. 8 illustrates a server according to an embodiment.

### DETAILED DESCRIPTION OF THE INVENTION

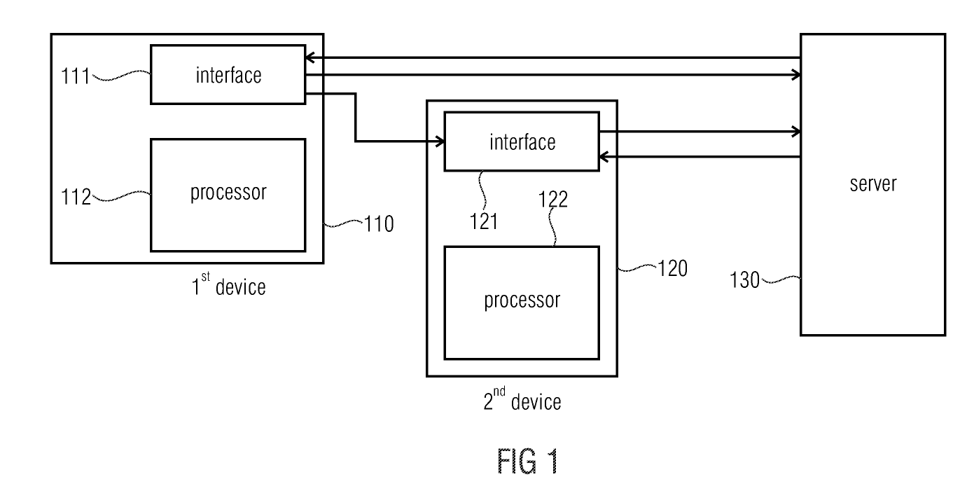

FIG. 1 illustrates a system according to an embodiment.

Embodiments realize session mobility. The transferring of the actual session parameters could take place directly between both devices or through another device, e.g., the HTTP Server. Moreover, the session can be actively transferred by one device or offered by a device in a way that other devices can take over the offered session. In comparison to traditional streaming approaches, in adaptive bitrate streaming systems multiple parameters, e.g., download & playback history, playback state, presentation time, consumed representation (view angle), language, DRM keys, etc. are handed over to the other device to enable a high quality experience for the user.

The system of FIG. 1 comprises a server 130, a first device 110 for receiving a first plurality of segments of a media data stream from the server 130, and a second device 120 for receiving a second plurality of segments of the media data stream from the server 130.

An interface 111 of the first device 110 is configured to receive manifest information indicating, for each property of one or more properties of the media data stream, a group of two or more available versions of said property of the media data stream.

Such properties of a media data stream, may, for example, be the available data rates, the available audio tracks or the available subtitles. Examples of versions of the properties may, for example, be “1 mbps”, “2 mbps” and “5 mbps” for the available data rates of the media data stream; “English”, “French” and “German” for the available audio tracks of the media data stream; or “English”, “French”, “German”, “Spanish”, “Italian” and “Swedish” for the available subtitles of the media data stream.

A processor 112 of the first device is configured to select, for each of the one or more properties, one of the two or more available versions of said property as a selected version of said property, to determine context information comprising the selected version of each of the one or more properties.

So, one of the available versions for each of the one or more properties is selected as selected version for each property. For example, 2 mbps is selected as the data rate, “English” is selected as the audio track, and “Italian is selected as the subtitle.

The interface 111 of the first device 110 is configured to request said first plurality of segments of the media data stream depending on the context information.

For example, if the context information specifies, that for the property “data rate” the selected version is “2 mbps”, then the interface 111 requests those segments of the media data stream that have a data rate of 2 mbps. For example, when, e.g., the three versions of the data rate are available, namely, 1 mbps, 2 mbps, and 5 mbps, three different segment folders may exist at the server 130, the first folder comprising a 1 mbps version of the data stream, wherein the segments of that first version all have a data rate of 1 mbps, the second folder comprising a 2 mbps version of the data stream, wherein the segments of that second version all have a data rate of 2 mbps, and the third folder comprising a 5 mbps version of the data stream, wherein the segments of that third version all have a data rate of 5 mbps. When the first device 110 or the second device 120 wants to request a segment of the data stream with the segment number 1718 having a data rate version of 2 mbps, the first device 110 or the second device 120 may, e.g., specify the parameters “1718” and “2 mbps” in the request. The server 130 may, e.g., then transmit the segment with the segment number 1718 being stored in the second folder (the 2 mbps folder) to the requesting device 110 or 120.

The server 130 is configured to transmit said first plurality of segments to the first device 110.

An interface 121 of the second device 120 is configured to receive the context information and information on a replay offset or on a segment being rendered last by the first device 110 or on a segment being received last by the first device 110, wherein said replay offset depends on a replay of the media data stream at the first device 110.

So, according to embodiments, the interface 121 of the second device 120 receives:

(a) the context information and
(b) information on the replay offset, and/or
information on the segment being rendered last by the first device 110, and/or
information on the segment being received last by the first device 110.

A processor 122 of the second device 120 is configured to select said second plurality of segments of the media data stream depending on the context information, and depending on the replay offset or on the segment being rendered last by the first device 110 or on the segment being received last by the first device 110.

For example, a user may, for example, have started to watch a video stream on a computer (e.g. the first device 110). The user wants to continue watching the video on his smartphone (e.g., the second device 120).

The information on the selected version of the one or more properties of the media data stream is received by the second device 120 on which streaming of the media data stream is continued.

Moreover, regarding the replay offset, a replay offset, may, for example, identify the time, from which the media data stream shall be replayed. This replay offset may, for example, be represented by a time, for example, identified by an offset. For example, an replay offset of 30:20 may indicate that the video on the second device 120 shall be started at 30 minutes, 20 seconds after the start time 00:00 of the video.

Alternatively or additionally to the replay offset, information on the segment being rendered last by the first device 110 and/or information on the segment being received last by the first device 110 may be transmitted. The segment being received last by the first device 110 indicates the most recently received segment that the first device 110 received before it stopped to receive the segments of the data stream. For example, the segment with segment number 1821 was the last received segment and this information on the segment number 1821 is received by the second device 120.

So, if, for example, the second device 120 receives the information that segment number 1254 was the last segment received by the first device 110, then the second device may request, for example, segment 1255 of the media data stream as its first requested segment, or, for example, may, in other embodiments, request segment 1254 of the media data stream as its first requested segment.

However, in embodiments, the segments may be buffered at the first device 110 before they are replayed. When the first device 110 stops receiving the segments of the media data stream, some of the received segments may still be in the buffer of the first device 110, and in some embodiments, these segments in the buffer may not be rendered/replayed at the first device 110, when the first device 110 stops receiving of the segments of the media data stream.

In such embodiments, it is useful to transmit the information on the segment being (e.g., decoded and) rendered (replayed) last by the first device 110 to the second device. The segment being rendered last by the first device 110 indicates the segment that was most recently rendered at the first device 110. So, for example, the second device 120 may, e.g., receive the information that the segment rendered last by the first device 110 was the segment with segment number 1816. The second device 120 may use this information to, for example, request segments of the media data stream starting with the segment with segment number 1817 (or with segment number 1816, depending on the implementation).

If, instead, in such cases the second device 120 would start with replaying the segment last received by the first device (here: the segment with segment number 1821), the segments 1817, 1818, 1819 and 1820 would not have been replayed by any of the two devices 110 and 120. So, informing the second device 120 about the segment being rendered/replayed last by the first device 110 is advantageous for particular embodiments.

The interface 121 of the second device 120 is configured to request said second plurality of segments from the server 130. The server 130 is configured to transmit said second plurality of segments to the second device 120.

In an embodiment, the interface 111 of the first device 110 may, e.g., be configured to request said first plurality of segments of the media data stream depending on the context information, by transmitting a first message comprising the context information and a first indication of a first segment of the first plurality of segments, and by transmitting a second message comprising the context information and a second indication of a second segment of the first plurality of segments. The server 130 may, e.g., be configured to transmit said first plurality of segments to the first device 110, by transmitting the first segment of the first plurality of segments to the first device 110 when the server 130 receives said first message, and by transmitting the second segment of the first plurality of segments to the first device 110 when the server 130 receives said second message. The interface 121 of the second device 120 may, e.g., be configured to request said second plurality of segments of the media data stream depending on the context information, by transmitting a third message comprising the context information and a third indication of a third segment of the second plurality of segments, and by transmitting a fourth message comprising the context information and a fourth indication of a fourth segment of the second plurality of segments. The server 130 may, e.g., be configured to transmit said second plurality of segments to the second device 120, by transmitting the third segment of the second plurality of segments to the second device 120 when the server 130 receives said third message, and by transmitting the fourth segment of the second plurality of segments to the second device 120 when the server 130 receives said fourth message.

In such an embodiment, the context information is transmitted with every request of the first device 110 or the second device 120. This means, the server 130 does not need at all to permanently keep any information about the current streaming session. Instead, all session information is kept at the respective device/client 110, 120 and transmitted to the server 130 with each segment request, e.g., by transmitting the context information.

According to an embodiment, the segments of the data stream are ordered, and wherein the processor 122 of the second device 120 may, e.g., be configured to select said second plurality of segments of the media data stream depending on the replay offset or on the segment being rendered last by the first device 110 or on the segment being received last by the first device 110, so that each of said second plurality of segments being selected by the processor 122 of the second device 120 is the segment being rendered last by the first device 110 or a successor of the segment being rendered last by the first device 110 or is the segment being received last by the first device 110 or a successor of the segment being received last by the first device 110.

In an embodiment, the interface 121 of the second device 120 may, e.g., be configured to receive the context information and the information on the replay offset of the media data stream or on the segment being rendered last by the first device 110 or on the segment being received last by the first device 110, by receiving a context message, wherein the context message may, e.g., comprise a first message portion indicating the selected version of each of the one or more properties of the context information, and wherein the context message comprises a second message portion indicating the segment being rendered last by the first device 110 or indicating the segment being received last by the first device 110.

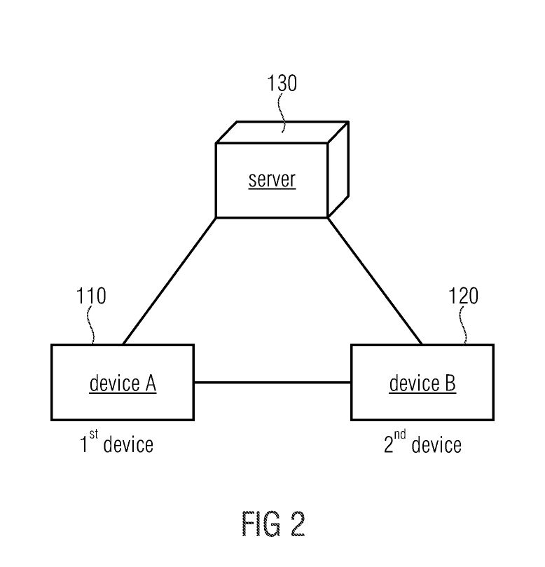

FIG. 2 illustrates a session mobility architecture according to an embodiment. Embodiments provides session mobility, the transferring of an active or inactive streaming session from one device to another.

The transferring of the actual session parameters could take place directly between both devices or through another device, e.g., the HTTP Server. For transmission, e.g. via NFC, Bluetooth, Wifi, 3G or Email, may be employed. Moreover, the session can be actively transferred by one device or offered by a device in a way that other devices can take over the offered session. In comparison to traditional streaming approaches, in adaptive bitrate streaming systems multiple parameters, e.g., download & playback history, playback state, presentation time, consumed representation (view angle), language, DRM keys, etc. are handed over to the other device to enable a high quality experience for the user.

Embodiments provide handover concepts of such information for devices. Concepts are provided for devices which are compatible. Further concepts are provided for devices which are incompatible.

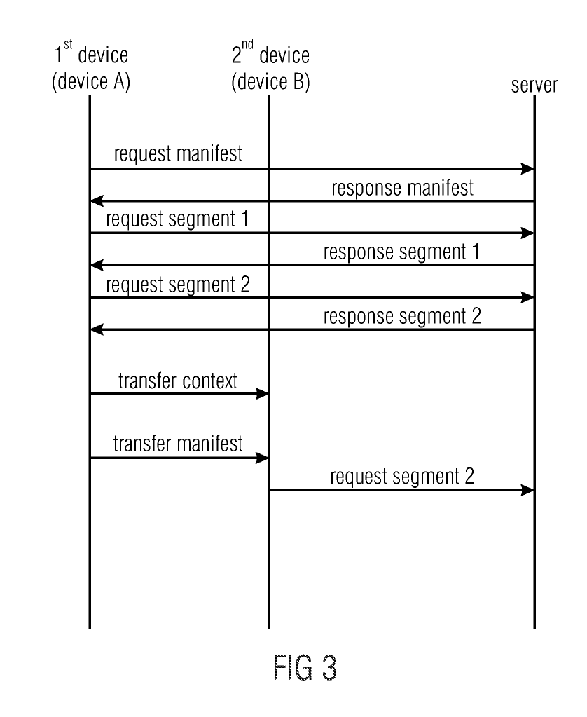

FIG. 3 illustrates a session mobility architecture according to another embodiment with compatible devices. Compatible devices that are using the same or interoperable software/hardware can act as shown in FIG. 3.

For example Device A starts a media streaming session where it initially requests a Manifest that describes the content and the inter-temporal relationships between the individual representations of the content and the segments. Afterwards, Device A can decide to handover the streaming session to Device B, which means that Device B has been located through the Network, Bluetooth, NFC, etc. Alternatively, Device A can also offer the streaming session for other devices through the Network, Bluetooth, NFC, etc., and Device B can connect to Device A. In both cases Device A will transfer the current context of the session that includes, information about already downloaded and played segments, the playback state, DRM keys, language, used representation, etc. to Device B. After that it can handover the Manifest file that has been downloaded from the content server or the URL of the Manifest to Device B, which can immediately start the streaming session with the modified parameters that it has received from Device A. Therefore, Device B needs to understand the information that has been handed over by Device A, which means that both devices need have software or hardware installed that provides interoperability for the exchange, the interpretation and the combination of the data.

So, according to an embodiment, the interface 111 of the first device 110 may, e.g., be configured to transmit the manifest information indicating, for each property of one or more properties of said data stream, the group of the two or more available versions of said property of the data stream, to the second device 120. The interface 111 of the first device 110 may, e.g., be configured to transmit the context information comprising, for each of the one or more properties, the selected property of the two or more available versions of said property, to the second device 120. The interface 121 of the second device 120 may, e.g., be configured to receive the manifest information and the context information from the first device 110.

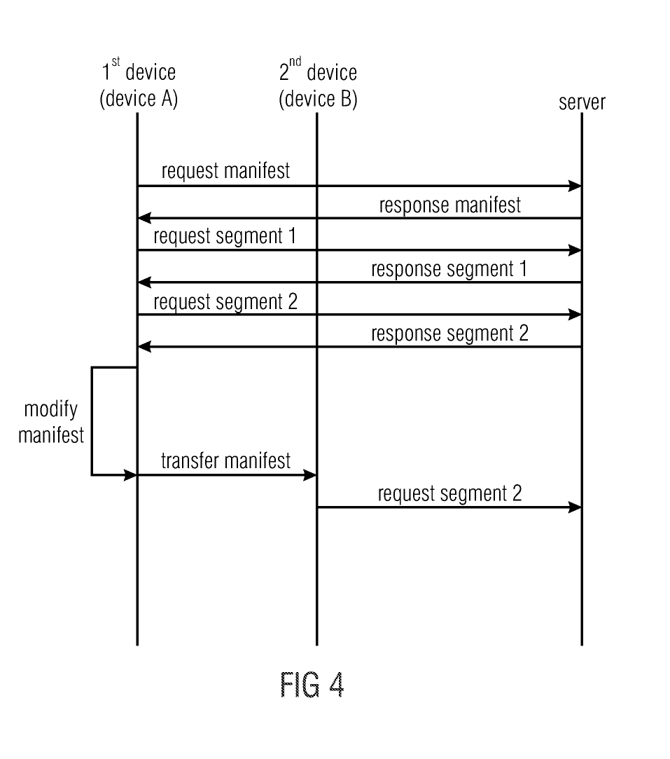

FIG. 4 illustrates a session mobility architecture according to a further embodiment with incompatible devices, wherein device A understands the manifest. In FIG. 4, where Device A and B are incompatible but both are able to consume adaptive bitrate media. Therefore, Device A modifies the Manifest in such a way that Device B will start the streaming session with an offset. This can be achieved with various methods such as in case of Dynamic Adaptive Streaming over HTTP (DASH) one can modify the Manifest into a “dynamic” and through the “availability start time” attribute the presentation offset can be set. Alternatively in other streaming systems similar techniques are available to modify the Manifest in such a way that it is compliant to the given standard and interpretable by Device B. Using this technique for the transfer has the advantage that Device B does not have to interpret or combine the information from Device A. Device B only has to know the given adaptive media streaming standard, such as Microsoft® Smooth Streaming, Apple® HTTP Live Streaming, Adobe® Dynamic HTTP Streaming or MPEG Dynamic Adaptive Streaming over HTTP. Anyway, Device A needs to understand the used media streaming standard mechanisms that can be used to modify the Manifest correctly.

So according to an embodiment, the interface 111 of the first device 110 of FIG. 1 may, e.g., be configured to receive the manifest information as received manifest information, said received manifest information indicating, for each property of the one or more properties of said data stream, the group of two or more available versions of said property of the data stream. Moreover, the interface 111 of the first device 110 may, e.g., be configured to modify the received manifest information to obtain modified manifest information, such that said modified manifest information indicates at least one of the context information and the information on a replay offset and the information on the segment being rendered last by the first device 110 and the information on the segment being received last by the first device 110, by receiving the modified manifest information. The interface 121 of the second device 120 may, e.g., be configured to receive at least one of the context information and the information on a replay offset and the information on the segment being rendered last by the first device 110 and the information on the segment being received last by the first device 110, by receiving the modified manifest information.

According to an embodiment, the processor 112 of the first device 110 may, e.g., be configured to modify the received manifest information to obtain modified manifest information, such that said modified manifest information indicates the replay offset or the segment being rendered last by the first device 110 or the segment being received last by the first device 110. Moreover, the interface 111 of the first device 110 may, e.g., be configured to transmit the modified manifest information to the second device 120. The interface 121 of the second device 120 may, e.g., be configured to receive the context information and to receive the information on the replay offset or on the segment being rendered last by the first device 110 or on the segment being received last by the first device 110 by receiving the modified manifest information from the first device 110.

For example, the available versions of the property “audio track” of a media data stream may be “English”, “French” and “German”. The user at the first device/client 110 may have selected “German”. When the first device 110 stops receiving segments, the first device modifies the manifest and deletes “English” and “French” from the modified manifest, so that only the version “German” is indicated as being available. The modified manifest is then transmitted to the second device/client 120 and when the second device 120 reads the modified manifest, it concludes that “German” has to be chosen as “audio track”. An advantage is, that a second device 120 only has to understand (the syntax of) the manifest, by does not need to understand, the (possibly, device-specific) context information. Instead, the first client prepares the manifest accordingly.

In some embodiments, only some properties are restricted to the selected version in the modified manifest information while the available version of other properties may not be restricted in the modified manifest information, e.g., the modified manifest file. For example, in the above example, the modified manifest information may only indicate “German” as available “audio track”, while all available subtitle versions, e.g., “English”, “French”; “German”; “Italian”, “Spanish” and “Swedish” as still indicated as being available in, e.g., a modified manifest file.

In further embodiment, some of the available versions of a property of the media data stream may be restricted to a preselection. For example, if in an initial manifest information, “English”, “French” and “German” are available as audio tracks, the first device 110 may preselect “English” and “German”. When ending receiving the segments of the media data stream, the first device 110 may remove only “French” from the modified manifest information, and may transmit this modified manifest to the second device. The modified manifest information then indicates only “German” and “English” as available audio tracks.

Regarding the information replay offset or the information on the segment being rendered last by the first device 110 or the information on the segment being received last by the first device 110, such information may be transmitted within the manifest information. For example, the first device 110 may modify the manifest information, such that the modified manifest information comprises the information on the replay offset or on the segment being rendered last by the first device 110 or on the segment being received last by the first device 110.

In an embodiment, the processor 112 of the first device 110 may, e.g., be configured to modify the received manifest information to obtain modified manifest information, such that said modified manifest information indicates for each property of said one or more properties of said data stream, one or more available versions of said group of two or more available versions of said property of the data stream, such that the selected version of said property is among the one or more available versions indicated by the modified manifest information for said property, and such that said modified manifest information indicates for a property of the one or more properties of said data stream, exactly one available version of the group of two or more available versions of said property of the data stream, said exactly one available version of said property being the selected version of said property of the context information. Moreover, the interface 111 of the first device 110 may, e.g., be configured to transmit the modified manifest information to the second device 120. Furthermore, the interface 121 of the second device 120 may, e.g., be configured to receive the context information by receiving the modified manifest information from the first device 110.

In such an embodiment, for a property (this means for at least one property) of two or more properties of the data stream, exactly one available version of said property of the data stream is indicated in the modified manifest information.

According to an embodiment, the processor 112 of the first device 110 may, e.g., be configured to modify the received manifest information to obtain modified manifest information, such that said modified manifest information indicates for each property of the one or more properties of said data stream, exactly one available version of the group of two or more available versions of said property of the data stream, said exactly one available version of said property being the selected version of said property of the context information.

In such an embodiment, for each property of the properties of the data stream, exactly one available version of said property of the data stream is indicated in the modified manifest information.

In an embodiment, the interface 121 of the second device 120 may, e.g., be configured to receive at least one of the context information and the information on a replay offset and the information on the segment being rendered last by the first device 110 and the information on the segment being received last by the first device 110, by receiving the modified manifest information. The modified manifest information may, e.g., comprise a plurality of tagged information elements, wherein a property of each of the plurality of tagged information elements is characterized by a start tag and by an end tag being assigned to said start tag. The processor 122 of the second device 120 may, e.g., be configured to analyse the at least one of the start tag and the end tag of at least one of the tagged information elements of the modified manifest information to determine, whether the processor 122 of the second device 120 is adapted to interpret the said tagged information element. The processor 122 of the second device 120 may, e.g., be configured to select at least one of said second plurality of segments of the media data stream depending on said tagged information element, if the processor 122 of the second device 120 is adapted to interpret the said tagged information element. The processor 122 of the second device 120 may, e.g., be configured to not select any of said second plurality of segments of the media data stream depending on said tagged information element, if the processor 122 of the second device 120 is not adapted to interpret said tagged information element.

These embodiments relate, for example, to markup language representations of the modified manifest file. For example, XML is a markup language. An information element starts with a start tag, for example, the start tag “<audio track>” and ends with an end tag, being assigned to the start tag, for example, the end tag “</audio track>. The (combined) information element

<audio track><version>English</version><version>French</version><version>German</version></audio track>
may, for example, indicate that the available versions of the property “audio track” of the media data stream are English, French and German.

Employing a representation using tagged information elements for the (initial or modified) manifest file has an advantage, as, the devices 110, 120, for example, the second device, can immediately judge from analysing the start tag, whether it can interpret the information contained in the information element. Information, encoded by the first device 110, that cannot be interpreted by the second device 120, can be immediately ignored by the second device 120 when analysing the start tag. This supports interoperability and accelerates processing.

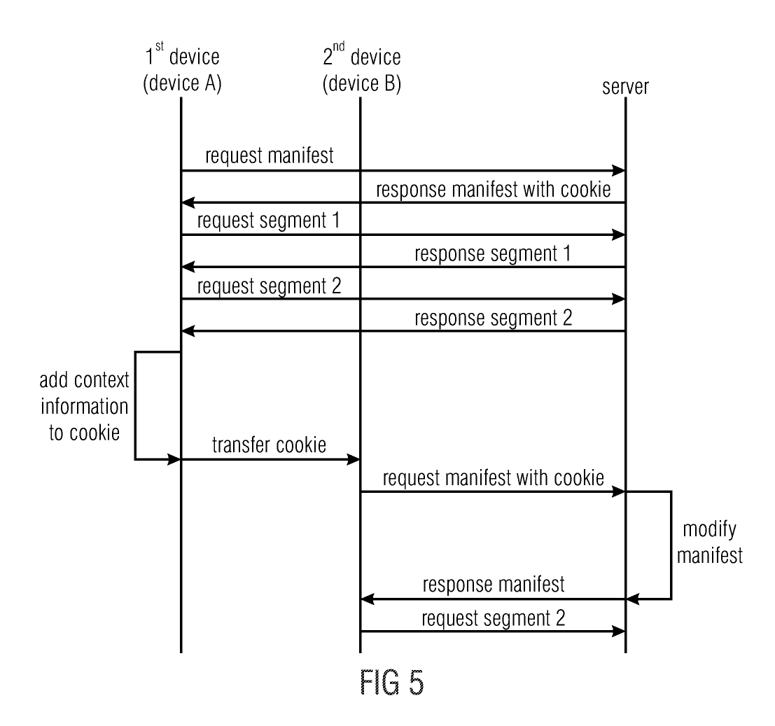

FIG. 5 illustrates a session mobility architecture according to another embodiment with incompatible Devices, wherein a server based modification employs one or more cookies. In particular, FIG. 5 illustrates an approach where Device A does not know how to modify the Manifest correctly so that Device B will start the presentation with the offset as needed. In this scenario the Server keeps track of the session through additional information which will be send to the client in the corresponding response to the Manifest request. In case of the HTTP protocol this could be achieved through cookies that will be send with the Manifest from the Server. Additionally, Device A requests the individual segments with that information or the cookie so that the Server can keep track of the session. When Device A transfers the streaming session to Device B it will also transfer its cookie or other information that has been received from the Server to Device B. Additionally, Device A can also add information to the cookie such as, playback state, presentation time etc. Device B will request the Manifest with the cookie from the Server and the Server will respond with an modified Manifest that starts at the time when Device A has transferred the session to Device B.

According to such an embodiment, processor 112 of the first device 110 may, e.g., be configured to generate a HTTP cookie comprising the context information and information on a replay offset or on the segment being rendered last by the first device 110 or on the segment being received last by the first device 110, wherein said replay offset depends on a replay of the media data stream at the first device 110. The interface 111 of the first device 110 may, e.g., be configured to transmit the HTTP cookie to the second device 120 or to the server 130. The server 130 may, e.g., be configured to receive the HTTP cookie. The manifest information may, e.g., be an initial manifest information, and wherein the server 130 is configured to modify the initial manifest information to obtain modified manifest information depending on the HTTP cookie, such that said modified manifest information indicates at least one of the context information and the information on a replay offset and the information on the segment being rendered last by the first device 110 and the information on the segment being received last by the first device 110, by receiving the modified manifest information. The interface 121 of the second device 120 may, e.g., be configured to receive at least one of the context information and the information on a replay offset and the information on the segment being rendered last by the first device 110 and the information on the segment being received last by the first device 110, by receiving the modified manifest information from the server 130.

Employing HTTP cookies for transmitting the information is advantageous because of the interoperability.

For example, according to an embodiment, a digital item (e.g., an MPEG-21 digital item) may, e.g., be employed, e.g., to transmit the context information.

Or, in another embodiment, an XML-Patch may be employed, e.g., to transmit the context information. An XML-Patch may, for example, comprise information, how an XML file shall be modified. For example, initial manifest information may be an XML-file, and the XML-patch may comprise information, how the XML-file comprising the initial manifest information shall be modified to obtain the modified manifest information. The XML-patch may itself be a file, for example, may itself be an XML-file.

In another embodiment, the whole modified MPD may be transmitted to the server.

In such embodiments, devices/clients only need to understand the manifest information, e.g. the media presentation description (MPD), and the conducted modification. In an embodiment, the manifest information may be represented according to a representation that satisfies RFC 5261 (see: http://tools.ietf.org/html/rfc5261).

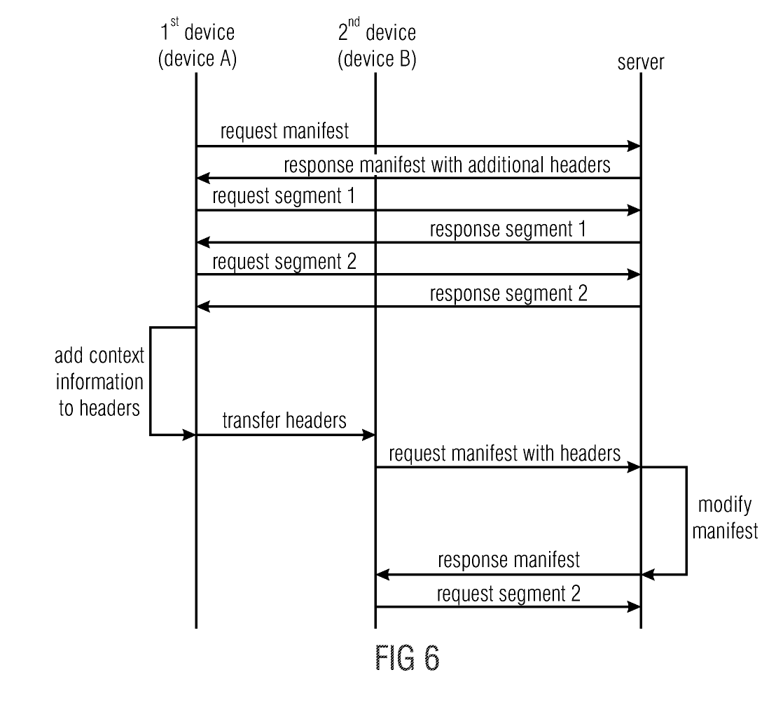

FIG. 6 illustrates a session mobility architecture according to a further embodiment with incompatible devices, wherein a server based modification employs headers.

So according to such an embodiment, the processor 112 of the first device 110 may, e.g., be configured to generate one or more headers of a message, said one or more headers comprising the context information and information on a replay offset or on the segment being rendered last by the first device 110 or on the segment being received last by the first device 110, wherein said replay offset depends on a replay of the media data stream at the first device 110. The interface 111 of the first device 110 may, e.g., be configured to transmit the one or more headers to the second device 120 or to the server 130. The server 130 may, e.g., be configured to receive the one or more headers. The manifest information may, e.g., be an initial manifest information, and wherein the server 130 is configured to modify the initial manifest information to obtain modified manifest information depending on the one or more headers, such that said modified manifest information indicates at least one of the context information and the information on a replay offset and the information on the segment being rendered last by the first device 110 and the information on the segment being received last by the first device 110, by receiving the modified manifest information. The interface 121 of the second device 120 may, e.g., be configured to receive at least one of the context information and the information on a replay offset and the information on the segment being rendered last by the first device 110 and the information on the segment being received last by the first device 110, by receiving the modified manifest information from the server 130.

In the scenario of FIGS. 5 and 6, the server, for example, receives the context information, e.g., by receiving a cookie or header information, and modifies initial manifest information, for example, as described above. For example, available versions of one or more of the properties of the data stream may be deleted from the manifest information.

For example, the available versions of the property “subtitle” of a media data stream may be “English”, “French”, “German”, “Italian”, “Spanish” and “Swedish”. The user at a first device may have selected “Italian”. When the first device stops receiving segments, this (portion of) the context information is transmitted to the server, e.g., via the second device, which continues receiving the segment. The server then modifies the manifest and deletes “English”, “French”, “German”, “Spanish” and “Swedish” from the modified manifest, so that only the version “Italian” is still available. The modified manifest is then transmitted to the second device and when the second device reads the modified manifest, it concludes that “Italian” has to be chosen as “subtitle”. An advantage is, that a second device only has to understand (the syntax of) the manifest, by does not need to understand, the possibly, device-specific, context information. Instead, it is sufficient, if only the server is capable of understanding the, possibly device-specific context information of the devices. Moreover, it is particularly advantageous to transmit the context information to the server, if the first device 110 of FIG. 1 does not know how to modify the manifest, so that the second device 120 can understand the modified manifest. In such a case, the server 130 modifies the manifest information as described with reference to FIGS. 5 and 6.

For example, regarding some kind of videos, two or more media data streams may be employed to transmit the video. For example, a first one of the media data streams may, e.g., transmit the image information, and a second one of the media data streams may, e.g., transmit the sound information. For example, a third media data stream may, e.g., transmit the subtitles. In such cases where two or more media data streams are transmitted, the manifest information may, e.g., comprise information on the available versions of the properties of each of the data streams, and the context information may, e.g., specify the selected version of each of the properties of each of the two or more media data streams.

According to such embodiments, the media data stream may, e.g., be a first media data stream. The first device 110 may, e.g., be configured to receive a third plurality of segments of the second media data stream from the server 130. The second device 120 may, e.g., be configured to receive a fourth plurality of segments of the second media data stream from the server 130. The interface 111 of the first device 110 may, e.g., be configured to receive manifest information indicating, for each property of one or more properties of the second media data stream, a group of two or more available versions of said property of the second media data stream. The processor 112 of the first device 110 may, e.g., be configured to select, for each of the one or more properties of the second media data stream, one of the two or more available versions of said property as a selected version of said property of the second media data stream, to determine the context information, wherein the context information further comprises the selected version of each of the one or more properties of the second media data stream. The interface 111 of the first device 110 may, e.g., be configured to request said third plurality of segments of the second media data stream depending on the context information. The server 130 may, e.g., be configured to transmit said third plurality of segments to the first device 110. The interface 121 of the second device 120 may, e.g., be configured to further receive information on a further replay offset or on the segment of the second media data stream being rendered last by the first device 110 or on the segment of the second media data stream being received last by the first device 110, wherein said further replay offset depends on a replay of the second media data stream at the first device 110. The processor 122 of the second device 120 may, e.g., be configured to select said fourth plurality of segments of the second media data stream depending on the context information, and depending on the further replay offset or on the segment of the second media data stream being rendered last by the first device 110 or on the segment of the second media data stream being received last by the first device 110. The interface 121 of the second device 120 may, e.g., be configured to request said fourth plurality of segments from the server 130. The server 130 may, e.g., be configured to transmit said fourth plurality of segments to the second device 120.

In an embodiment, the first media data stream may, e.g., be a video data stream, and/or the second media data stream may, e.g., be an audio data stream.

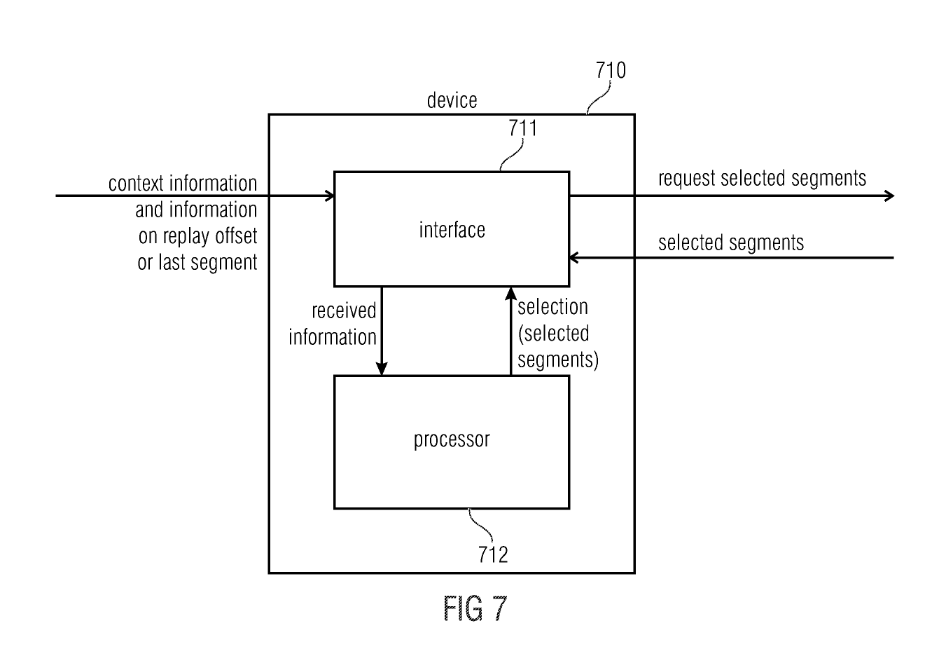

FIG. 7 illustrates a device 710 for receiving a plurality of segments of a media data stream according to an embodiment. In embodiments, the first device 110 and/or the second device 120 of one of FIGS. 1 to 6 may, for example, be configured as described with reference to FIG. 7 in the following. Likewise, in embodiments, the device 710 of FIG. 7 may be configured as described for the first device 110 and/or the second device 120 in the description above that made reference to FIGS. 1 to 6.

The device 710 of FIG. 7 comprises an interface 711 for receiving context information and information on a replay offset or on a segment being rendered last by another device or on a segment being received last by the other device, wherein said replay offset depends on a replay of the media data stream at said other device.

Moreover, the device 710 comprises a processor 712 for selecting said plurality of segments of the media data stream depending on the context information, and depending on the replay offset or on the segment being rendered last by said other device or on the segment being received last by said other device.

The interface 711 is configured to request said plurality of segments. Moreover, the interface 711 is configured to receive said plurality of segments.

In an embodiment, the device is capable of receiving context information from a second device which previously received segments of the media data stream, but, moreover, the device is also capable of transmitting its own context information, when the device stops receiving the portions of the media data stream. Thus, in such an embodiment, the device has the capability of receiving and processing (“foreign”) context information, as well as the capability of generating and transmitting (its own) context information.

So to also generate “own” context information that shall be transmitted to a “third device”, in such an embodiment, the interface 711 of the device 710 may, e.g., moreover be configured to receive manifest information indicating, for each property of one or more properties of the media data stream, a group of two or more available versions of said property of the media data stream.

The processor 712 of the device 710 may, e.g., be configured to select, for each of the one or more properties, one of the two or more available versions of said property as a selected version of said property, to determine further context information (its own) comprising the selected version of each of the one or more properties.

The interface 711 of the device 710 may, e.g., be configured to request said another plurality of segments of the media data stream depending on the further context information. Moreover, the interface 711 of the device 710 may, e.g., be configured to transmit information on the further context information and information on a further replay offset or on the segment being rendered last by the device 710 or on the segment being received last by the device 710, wherein said further replay offset depends on a replay of the media data stream at the device 710.

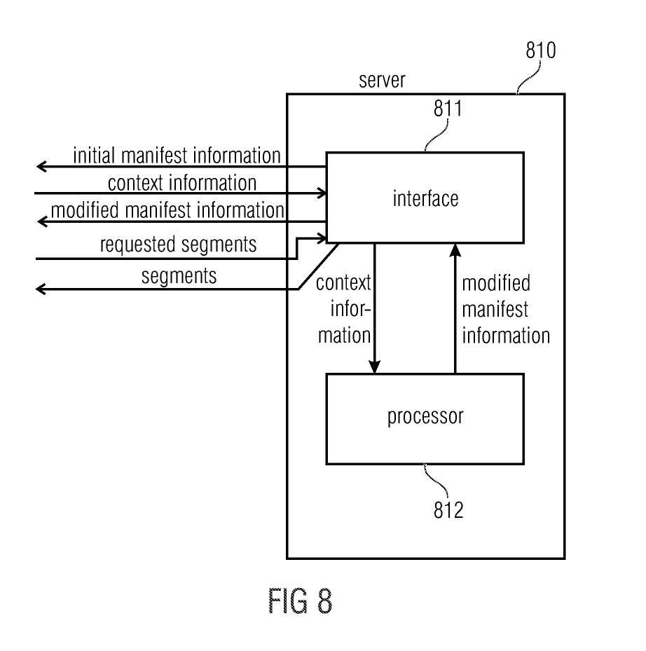

FIG. 8 illustrates a server according to an embodiment. In embodiments, the server of one of FIGS. 1 to 6 may, for example, be configured as described with reference to FIG. 8 in the following. Likewise, in embodiments, the server 810 of FIG. 8 may be configured as described for the server 130 in the description above that made reference to FIGS. 1 to 6.

The server 810 of FIG. 8 comprises an interface 811 for transmitting initial manifest information indicating two or more versions for each of one or more properties of a media data stream and a processor 812.

The interface 811 is configured to receive context information indicating a selected version for each of the one or more properties of the media data stream.

The processor 812 is configured to modify the initial manifest information to obtain modified manifest information depending on the context information.

The interface 811 is configured to transmit the modified manifest information. Moreover, the interface 811 is configured to receive a request requesting one or more segments of the media data stream, wherein the request depends on the modified manifest information. Furthermore, the interface 811 is configured to transmit said one or more segments of the media data stream.

Such a server 810 acts, for example, as described for the server in FIGS. 5 and 6. The interface of the server 810, for example, receives the context information, e.g., by receiving a cookie or header information, and modifies the initial manifest information, for example, as described above. For example, available versions of one or more of the properties of the data stream may be deleted from the manifest information.

For example, the available versions of the property “audio track” of a media data stream may be “English”, “French” and “German”. The user at a first device may have selected “German”. When the first device stops receiving segments, this (portion of) the context information is transmitted to the server 810, e.g., via the second device, which continues receiving the segment. The server 810 then modifies the manifest and deletes “English” and “French” from the modified manifest, so that only the version “German” is available. The modified manifest is then transmitted to the second device and when the second device reads the modified manifest, it concludes that “German” has to be chosen as “audio track”. An advantage is, that a second device only has to understand (the syntax of) the manifest, by does not need to understand, the possibly, device-specific, context information. Instead, it is sufficient, if only the server 810 understands the, possibly device-specific context information of the devices. Moreover, it is particularly advantageous to transmit the context information to the server, if the first device, which ends receiving the segments of the media data stream does not know how to modify the manifest, so that a second device, which wants to continue the receiving of the segments of the data stream, can understand the modified manifest. In such a case, the server 810 modifies the manifest information as described with reference to FIGS. 5 and 6. In such embodiments, only the server 810 has to be capable to modify the manifest information, but not the device which stops receiving the segments of the data stream.

Although some aspects have been described in the context of a system, device, apparatus or server, it is clear that these aspects also represent a description of the corresponding method, where a block or device corresponds to a method step or a feature of a method step. Analogously, aspects described in the context of a method step also represent a description of a corresponding block or item or feature of a corresponding system, device, apparatus or server.

The inventive decomposed signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a non-transitory data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] C. Mueller, C. Timmerer, “A Test-Bed for the Dynamic Adaptive Streaming over HTTP featuring Session Mobility”, ACM Multimedia Systems, San Jose, Calif., USA, February 2011, pp. 271-276.
[2] DE KEUKELAERE, Frederik; DE SUTTER, Robbie; VAN DE WALLE, Rik. MPEG-21 Session Mobility on Mobile Devices. In: International Conference on Internet Computing. 2005. S. 287-293.
[3] SONG, Yu, et al. Browser session mobility system for multi-platform applications. U.S. patent application Ser. No. 10/404,849, 2003.
[4] RFC 5261: Network Working Group; Request for Comments: 5261; September 2008 (http://tools.ietf.org/html/rfc5261).

1. A system, comprising:
a server,
a first device for receiving a first plurality of segments of a media data stream from the server, and
a second device for receiving a second plurality of segments of the media data stream from the server,
wherein an interface of the first device is configured to receive manifest information indicating, for each property of one or more properties of the media data stream, a group of two or more available versions of said property of the media data stream,
wherein a processor of the first device is configured to select, for each of the one or more properties, one of the two or more available versions of said property as a selected version of said property, to determine context information comprising the selected version of each of the one or more properties,
wherein the interface of the first device is configured to request said first plurality of segments of the media data stream depending on the context information,
wherein the server is configured to transmit said first plurality of segments to the first device,
wherein an interface of the second device is configured to receive the context information and information on a replay offset or on a segment being rendered last by the first device or on a segment being received last by the first device, wherein the replay offset depends on a replay of the media data stream at the first device,
wherein a processor of the second device is configured to select said second plurality of segments of the media data stream depending on the context information, and depending on the replay offset or on the segment being rendered last by the first device or on the segment being received last by the first device,
wherein the interface of the second device is configured to request said second plurality of segments from the server, and
wherein the server is configured to transmit said second plurality of segments to the second device.

2. The system according to claim 1,
wherein the interface of the first device is configured to request said first plurality of segments of the media data stream depending on the context information, by transmitting a first message comprising the context information and a first indication of a first segment of the first plurality of segments, and by transmitting a second message comprising the context information and a second indication of a second segment of the first plurality of segments,
wherein the server is configured to transmit said first plurality of segments to the first device, by transmitting the first segment of the first plurality of segments to the first device when the server receives said first message, and by transmitting the second segment of the first plurality of segments to the first device when the server receives said second message,
wherein the interface of the second device is configured to request said second plurality of segments of the media data stream depending on the context information, by transmitting a third message comprising the context information and a third indication of a third segment of the second plurality of segments, and by transmitting a fourth message comprising the context information and a fourth indication of a fourth segment of the second plurality of segments, and
wherein the server is configured to transmit said second plurality of segments to the second device, by transmitting the third segment of the second plurality of segments to the second device when the server receives said third message, and by transmitting the fourth segment of the second plurality of segments to the second device when the server receives said fourth message.

3. The system according to claim 1, wherein the segments of the data stream are ordered, and wherein the processor of the second device is configured to select said second plurality of segments of the media data stream depending on the replay offset or on the segment being rendered last by the first device or on the segment being received last by the first device, so that each of said second plurality of segments being selected by the processor of the second device is the segment being rendered last by the first device or a successor of the segment being rendered last by the first device or the segment being received last by the first device or a successor of the segment being received last by the first device.

4. The system according to claim 1, wherein the interface of the second device is configured to receive the context information and the information on the replay offset or on the segment being rendered last by the first device or on the segment being received last by the first device, by receiving a context message, wherein the context message comprises a first message portion indicating the selected version of each of the one or more properties of the context information, and wherein the context message comprises a second message portion indicating the segment being rendered last by the first device or the segment being received last by the first device.

5. The system according to claim 1,
wherein the interface of the first device is configured to transmit the manifest information indicating, for each property of one or more properties of said data stream, the group of the two or more available versions of said property of the data stream, to the second device,
wherein the interface of the first device is configured to transmit the context information comprising, for each of the one or more properties, the selected property of the two or more available versions of said property, to the second device, and
wherein the interface of the second device is configured to receive the manifest information and the context information from the first device.

6. The system according to claim 1,
wherein the interface of the first device is configured to receive the manifest information as received manifest information, said received manifest information indicating, for each property of the one or more properties of said data stream, the group of two or more available versions of said property of the data stream,
wherein the interface of the first device is configured to modify the received manifest information to acquire modified manifest information, such that said modified manifest information indicates at least one of the context information and the information on the replay offset and the information on the segment being rendered last by the first device and the information on the segment being received last by the first device, by receiving the modified manifest information,
wherein the interface of the second device is configured to receive at least one of the context information and the information on the replay offset and the information on the segment being rendered last by the first device and the information on the segment being received last by the first device, by receiving the modified manifest information.

7. The system according to claim 6,
wherein the processor of the first device is configured to modify the received manifest information to acquire modified manifest information, such that said modified manifest information indicates the replay offset or the segment being rendered last by the first device or the segment being received last by the first device,
wherein the interface of the first device is configured to transmit the modified manifest information to the second device, and
wherein the interface of the second device is configured to receive the context information and to receive the information on the replay offset or on the segment being rendered last by the first device or on the segment being received last by the first device, by receiving the modified manifest information from the first device.

8. The system according to claim 6,
wherein the processor of the first device is configured to modify the received manifest information to acquire modified manifest information, such that said modified manifest information indicates for each property of said one or more properties of said data stream, one or more available versions of said group of two or more available versions of said property of the data stream, such that the selected version of said property is among the one or more available versions indicated by the modified manifest information for said property, and such that said modified manifest information indicates for a property of the one or more properties of said data stream, exactly one available version of the group of two or more available versions of said property of the data stream, said exactly one available version of said property being the selected version of said property of the context information,
wherein the interface of the first device is configured to transmit the modified manifest information to the second device, and
wherein the interface of the second device is configured to receive the context information by receiving the modified manifest information from the first device.

9. The system according to claim 8, wherein the processor of the first device is configured to modify the received manifest information to acquire modified manifest information, such that said modified manifest information indicates for each property of two or more properties of said data stream, exactly one available version of the group of two or more available versions of said property of the data stream, said exactly one available version of said property being the selected version of said property of the context information.

10. The system according to claim 6,
wherein the interface of the second device is configured to receive at least one of the context information and the information on the replay offset and the information on the segment being rendered last by the first device and the information on the segment being received last by the first device, by receiving the modified manifest information,
wherein the modified manifest information comprises a plurality of tagged information elements, wherein a property of each of the plurality of tagged information elements comprises a start tag and by an end tag being assigned to said start tag,
wherein the processor of the second device is configured to analyse the at least one of the start tag and the end tag of at least one of the tagged information elements of the modified manifest information to determine, whether the processor of the second device is adapted to interpret the said tagged information element,
wherein the processor of the second device is configured to select at least one of said second plurality of segments of the media data stream depending on said tagged information element, if the processor of the second device is adapted to interpret the said tagged information element, and
wherein the processor of the second device is configured to not select any of said second plurality of segments of the media data stream depending on said tagged information element, if the processor of the second device is not adapted to interpret said tagged information element.

11. The system according to claim 1,
wherein the processor of the first device is configured to generate a HTTP cookie comprising the context information and the information on the replay offset or on the segment being rendered last by the first device or on the segment being received last by the first device,
wherein the interface of the first device is configured to transmit the HTTP cookie to the second device or to the server,
wherein the server is configured to receive the HTTP cookie,
wherein the manifest information is an initial manifest information, and wherein the server is configured to modify the initial manifest information to acquire modified manifest information depending on the HTTP cookie, such that said modified manifest information indicates at least one of the context information and the information on the replay offset and the information on the segment being rendered last by the first device and the information on the segment being received last by the first device, by receiving the modified manifest information, and
wherein the interface of the second device is configured to receive at least one of the context information and the information on the replay offset and the information on the segment being rendered last by the first device and the information on the segment being received last by the first device, by receiving the modified manifest information from the server.

12. The system according to claim 1,
wherein the processor of the first device is configured to generate one or more headers of a message, said one or more headers comprising the context information and the information on the replay offset or on the segment being rendered last by the first device or on the segment being received last by the first device,
wherein the interface of the first device is configured to transmit the one or more headers to the second device or to the server,
wherein the server is configured to receive the one or more headers,
wherein the manifest information is an initial manifest information, and wherein the server is configured to modify the initial manifest information to acquire modified manifest information depending on the one or more headers, such that said modified manifest information indicates at least one of the context information and the information on the replay offset and the information on the segment being rendered last by the first device and the information on the segment being received last by the first device, by receiving the modified manifest information, and
wherein the interface of the second device is configured to receive at least one of the context information and the information on the replay offset and the information on the segment being rendered last by the first device and the information on the segment being received last by the first device, by receiving the modified manifest information from the server.

13. The system according to claim 1,
wherein the media data stream is a first media data stream,
wherein the first device is configured to receive a third plurality of segments of the second media data stream from the server,
wherein the second device is configured to receive a fourth plurality of segments of the second media data stream from the server,
wherein the interface of the first device is configured to receive manifest information indicating, for each property of one or more properties of the second media data stream, a group of two or more available versions of said property of the second media data stream,
wherein the processor of the first device is configured to select, for each of the one or more properties of the second media data stream, one of the two or more available versions of said property as a selected version of said property of the second media data stream, to determine the context information, wherein the context information further comprises the selected version of each of the one or more properties of the second media data stream,
wherein the interface of the first device is configured to request said third plurality of segments of the second media data stream depending on the context information,
wherein the server is configured to transmit said third plurality of segments to the first device,
wherein the interface of the second device is configured to further receive information on a further replay offset or on the segment of the second media data stream being rendered last by the first device or on the segment of the second media data stream being received last by the first device, wherein the further replay offset depends on a replay of the second media data stream at the first device,
wherein the processor of the second device is configured to select said fourth plurality of segments of the second media data stream depending on the context information, and depending on the further replay offset or on the segment of the second media data stream being rendered last by the first device or on the segment of the second media data stream being received last by the first device,
wherein the interface of the second device is configured to request said fourth plurality of segments from the server, and
wherein the server is configured to transmit said fourth plurality of segments to the second device.

14. The system according to claim 13,
wherein the first media data stream is a video data stream, and
wherein the second media data stream is an audio data stream.

15. A device for receiving a plurality of segments of a media data stream, comprising:
an interface for receiving context information and information on a replay offset or on a segment being rendered last by another device or on a segment being received last by the other device, wherein the replay offset depends on a replay of the media data stream at the other device, and
a processor for selecting said plurality of segments of the media data stream depending on the context information, and depending on the replay offset or on the segment being rendered last by the other device or on the segment being received last by the other device,
wherein the interface is configured to request said plurality of segments, and
wherein the interface is configured to receive said plurality of segments.

16. The device according to claim 15,
wherein the interface of the device is configured to receive manifest information indicating, for each property of one or more properties of the media data stream, a group of two or more available versions of said property of the media data stream,
wherein the processor of the device is configured to select, for each of the one or more properties, one of the two or more available versions of said property as a selected version of said property, to determine further context information comprising the selected version of each of the one or more properties,
wherein the interface of the device is configured to request said another plurality of segments of the media data stream depending on the further context information, and
wherein the interface of the device is configured to transmit information on the further context information and information on a further replay offset or on the segment being rendered last by the device or on the segment being received last by the device, wherein the further replay offset depends on a replay of the media data stream at the device.

17. A server, comprising:
an interface for transmitting initial manifest information indicating two or more versions for each of one or more properties of a media data stream,
and a processor,
wherein the interface is configured to receive context information indicating a selected version for each of the one or more properties of the media data stream,
wherein the processor is configured to modify the initial manifest information to acquire modified manifest information depending on the context information,
wherein the interface is configured to transmit the modified manifest information,
wherein the interface is configured to receive a request requesting one or more segments of the media data stream, wherein the request depends on the modified manifest information, and
wherein the interface is configured to transmit said one or more segments of the media data stream.

18. A method, comprising:
transmitting manifest information to a first device, wherein the manifest information indicates, for each property of one or more properties of the media data stream, a group of two or more available versions of said property of the media data stream,
conducting a selection at the first device such that, for each of the one or more properties, one of the two or more available versions of said property are selected as a selected version of said property, to determine context information comprising the selected version of each of the one or more properties,
requesting by the first device a first plurality of segments of the media data stream depending on the context information,
transmitting said first plurality of segments from a server to the first device,
transmitting from the first device to a second device the context information and information on a replay offset or on a segment being rendered last by the first device or on a segment being received last by the first device, wherein the replay offset depends on a replay of the media data stream at the first device,
conducting a selection by the second device, such that a second plurality of segments of the media data stream is selected depending on the context information, and depending on the replay offset or on the segment being rendered last by the first device or on the segment being received last by the first device,
transmitting a request for said second plurality of segments from the second device to the server, and
transmitting said second plurality of segments from the server to the second device.

19. A method for receiving a plurality of segments of a media data stream, comprising:
receiving, at a first device, context information and information on a replay offset or on a segment being rendered last by another device or on a segment being received last by the other device, wherein the replay offset depends on a replay of the media data stream at a second device,
selecting at the first device said plurality of segments of the media data stream depending on the context information, and depending on the replay offset or on the segment being rendered last by the other device or on the segment being received last by the other device,
requesting said plurality of segments, and
receiving said plurality of segments.

20. A method, comprising:
transmitting initial manifest information indicating two or more versions for each of one or more properties of a media data stream,
receiving context information indicating a selected version for each of the one or more properties of the media data stream,
modifying the initial manifest information to acquire modified manifest information depending on the context information,
transmitting the modified manifest information,
receiving a request requesting one or more segments of the media data stream, wherein the request depends on the modified manifest information, and
transmitting said one or more segments of the media data stream.

21. A non-transitory digital storage medium having stored thereon a computer program for performing the method of claim 18 when said computer program is run by a computer.

22. A non-transitory digital storage medium having stored thereon a computer program for performing the method of claim 19 when said computer program is run by a computer.

23. A non-transitory digital storage medium having stored thereon a computer program for performing the method of claim 20 when said computer program is run by a computer.
